(19) United States
(12) Patent Application Publication
(10) Pub. No.: US 2003/0061515 A1
(43) Pub. Date: Mar. 27, 2003

(54) Capability-enabled uniform resource locator for secure web exporting and method of using same

(76) Inventors: Timothy Kindberg, Burlingame, CA (US); Benjamin Atkin, Ithaca, NY (US)

Correspondence Address: HEWLETT-PACKARD COMPANY, Intellectual Property Administration, P.O. Box 272400, Fort Collins, CO, 80527-2400, US

(21) Appl. No.: 09/967,146

(22) Filed: Sep. 27, 2001

(51) Int. Cl. H04L 9/00

(52) U.S. Cl. 713/201

(57) ABSTRACT

A mechanism for providing a user with selective access to resources on an intranet. In a communications network accessible using HTTP, a reverse proxy server is coupled to an intranet and also coupled to a browser enabled client. Requests for access to resources inside the intranet are made through the reverse proxy server. Access to the requested resource is provided to the client by means of a capability-enabled uniform resource locator (URI) having a character string that is produce by encoding an identification number and a random number. The character string, identification number and random number are associated with a database record accessed by the reverse proxy server to determine whether access is to be provided to the client, and what conditions to apply to the access when the capability-enabled URI is invoked. Multiple resources may be grouped together in a secure container to which access is provided. The capability-enabled URI may be used to provide access to common gateway interface (CGI) scripts.

### BACKGROUND OF THE INVENTION

1. Field of the Invention

This invention relates to secure network communications.

In particular, the invention relates to a mechanism for secure web exporting.

2. Related Art

Organizations which maintain a computer network frequently install a firewall around it to protect the computers inside from outside interference. Unfortunately, this also makes it difficult for legitimate users of the network to access it from outside the firewall. Typical systems for enabling access to outsider users rely on user authentication to secure channels of communication through the firewall. However, such access to the network is often an all-or-nothing affair: once inside, a user can access any files on a web server within the firewall. As a result, only trusted users can be allowed through. Secure external access is typically provided using a virtual private network (VPN).

A VPN can provide offsite employees secure access to their employer's network over the Internet. Although standards for Internet Protocol security (IPSEC) exist, they do not incorporate access control mechanisms at granularities lower than specific hosts.

More specific access to individual resources can be provided using a username and password, but this approach can be cumbersome for infrequent or temporary users.

Conventional systems may use a combination of authentication and access control lists to protect resources from non-privileged users. The use of access control lists to protect resources from users who do not belong to the organization is undesirable in that it is hard to predict who might access resources, and clients may be unknown, or may wish to remain anonymous.

Particularly relevant to the problem of providing wide area availability is the ability to provide mobile users access to resources and documents at the user's “home location”, even when at a remote site. Token based systems allow a remote user to gain access to specific documents from a remote location; however, such systems are still based upon the premise of authentication of a trusted user. In some cases it is desirable to provide access to visitors. Visitors typically do not have an established level of trust, particularly on their first visit.

The use of access control lists focuses on the user and not on the particular resources accessed by the user. Access control lists are typically managed by a central authority and this is in part due to the “all or nothing” character of access control lists. Users in general are restricted from granting access to resources, and access predicated on a limited duration or usage is not provided for. The centralized authority also lacks the flexibility of granting access through distributed mechanisms such as common gateway interface (CGI) scripts.

In most companies employees are trusted to have unrestricted access to computers and resources within the organization, while members of the general public can only access an external web server. However, there is a class of users between these two extremes, who are not trusted enough to be granted unrestricted access, but require access to some resources through the firewall, under carefully specified and monitored conditions.

Thus, there is a need for a mechanism which permits more selective access to resources within a network protected by a firewall. There is also a need for a mechanism that provides users the ability to control access to specific resources. Also, there is a need for automatically providing access conditioned on the basis of limited duration or usage.

### SUMMARY OF THE INVENTION

In one embodiment of the present invention, a local network capable of wireless communications is situated in an access controlled environment such as a corporate laboratory. A visitor desiring to make use of a public printer to get a hard copy of a document stored on his or her wireless-capable device is provided with a capability for use of a local printer within the laboratory. In this case, the placement of infrared beacons around the laboratory allows the visitor's device to obtain credentials proving it is inside the laboratory. These credentials are then used to communicate over the radio to a reverse proxy server on the lab's firewall, which transmits the request to the printer in the laboratory. To prevent the use of the credentials by a party outside the lab, the credentials can be given an expiration time or be limited in usage (e.g. the number of pages printed).

In another embodiment of the invention, a web-based content provider offers free use for a trial period, during which a prospective user can evaluate the service by watching actual broadcasts, as they happen—that is, to become a temporary subscriber. After the end of the trial period, the access is cut off unless the user subscribes for an entire month. Since the content (e.g. video program material) offered may take up a lot of disk space and the provider wants to offer prospective subscribers current information, simply putting some sample videos on its web site is unsatisfactory. Instead, it wishes to give people unrestricted access to current broadcasts for a limited duration, but not to its archives of past broadcasts, which are part of the subscription package. In this case, a prospective customer registers and receives some capabilities to access part of the members-only site, which expire at the end of the evaluation period.

In yet another embodiment of the invention, a person wishing to send a document to a receiving party is issued a capability that permits them to use the receiving party's web enabled printer. In this embodiment, a document can be transmitted and printed with better quality than a facsimile transmission and without requiring the receiving party to perform the printing operation. To prevent abuse, the capability may be limited to a given number of uses per unit time, and also limited to a certain number of pages.

In another embodiment of the invention, an organization undertaking a collaborative software development effort wishes to give to outside developers internal access to documentation for the software, source code repositories and other resources, without revealing anything else about the organization's business. The outside developers are issued capabilities that give them access to specific documents or groups of documents. The access provided to the outside developers may be modified or revoked without interfering with access by those working inside of the organization.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a computer system forming a part of a system in accordance with an embodiment of the present claimed invention.

FIG. 2 shows an exemplary network environment comprising the reverse proxy server of the present claimed invention.

FIG. 3 shows an embodiment of the capability-enabled Uniform Resource Locator (URL) of the present claimed invention.

FIG. 4 shows a representative database record in accordance with an embodiment of the present claimed invention.

FIG. 5 shows a flow chart for the process of providing a capability-enabled URL in accordance with an embodiment of the present claimed invention.

FIG. 6 shows a flow chart for the process of using a capability-enabled URL in accordance with an embodiment of the present claimed invention.

FIG. 7 shows a wireless network in accordance with an embodiment of the present claimed invention.

FIG. 8 shows a flow chart for the resolution of a common gateway interface (CGI) script in accordance with an embodiment of the present claimed invention.

FIG. 9A shows a secure container and documents to be added to the secure container in accordance with an embodiment of the present claimed invention.

FIG. 9B shows a secure container and the documents added to the secure container in accordance with an embodiment of the present claimed invention.

### DETAILED DESCRIPTION OF THE INVENTION

In the following detailed description of the present invention, a capability-enabled uniform resource locator for secure web exporting and method of using same, numerous specific details are set forth in order to provide a thorough understanding of the present invention. However, it will be obvious to one skilled in the art that the present invention may be practiced without these specific details. In other instances well known methods, procedures, protocols, and networks have not been described in detail so as not to unnecessarily obscure aspects of the present invention

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals a bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the disclosure of the present invention, terms such as “processing” or “computing” or “calculating” or “computing” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's registers or memories or other such information storage, transmission or display devices.

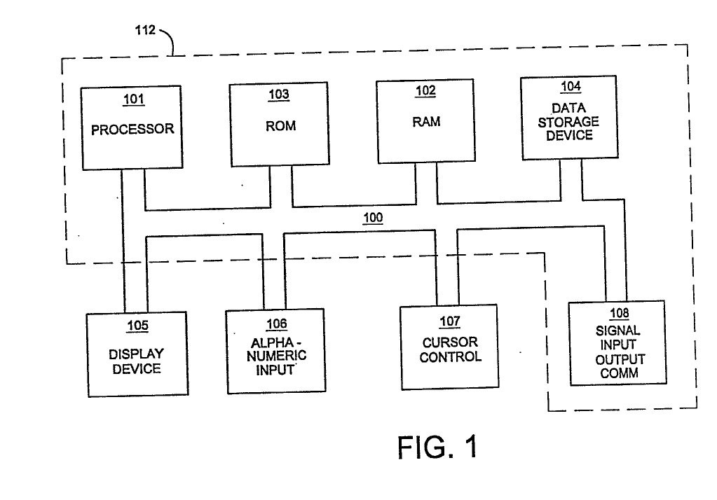

Refer to FIG. 1 which illustrates a computer system 112. In general, computer systems 112 used by the preferred embodiment of the present invention comprise a bus 100 for communicating information, a central processor 101 coupled with the bus for processing information and instructions, a random access memory 102 coupled with the bus 100 for storing information and instructions for the central processor 101, a read only memory 103 coupled with the bus 100 for storing static information and instructions for the processor 101, a data storage device 104 such as a magnetic or optical disk and disk drive coupled with the bus 100 for storing information and instructions, a display device 105 coupled to the bus 100 for displaying information to the computer user, an alphanumeric input device 106 including alphanumeric and function keys coupled to the bus 100 for communicating user input information and command selections to the central processor 101, cursor control device 107 coupled to the bus for communicating user input information and command selections to the central processor 101, and a signal generating device 108 coupled to the bus 100 for communicating command selections to the processor 101.

The display device 105 of FIG. 1 utilized with the computer system of the present invention may be a liquid crystal device, cathode ray tube or other display device suitable for creating graphic images and alphanumeric characters recognizable to the user. The cursor control device 107 allows the computer user to dynamically signal the two dimensional movement of a visible symbol (pointer) on a display screen of the display device 105. Many implementations of the cursor control device are known in the art including a trackball, mouse, joystick or special keys on the alphanumeric input device 105 capable of signaling movement of a given direction or manner of displacement. It is to be appreciated that the cursor means 107 also may be directed and/or activated via input from the keyboard using special keys and key sequence commands. Alternatively, the cursor may be directed and/or activated via input from a number of specially adapted cursor directing devices.

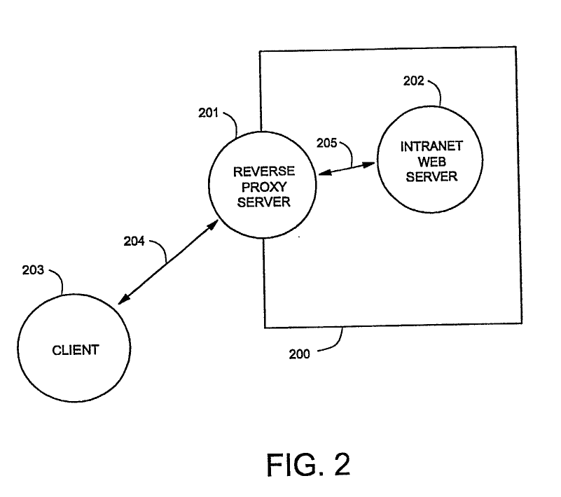

FIG. 2 shows a network environment having an intranet web server 202 protected by a firewall 200 and a reverse proxy server 201 on the firewall. The reverse proxy server 201 is coupled to the intranet web server 202 within the firewall protected domain 200 and is also coupled to a client 203 outside of the firewall. The coupling 205 between the reverse proxy server 201 and the intranet web server 202, and the coupling 204 between the reverse proxy server 201 and the client 203, may be a wired or wireless coupling. The environment shown in FIG. 2 is an example of an environment in which the present invention is used.

The intranet web server of FIG. 2 is a specific example of a web enabled resource. In general, a web enabled resource is a resource that is capable of responding to, or being delivered in response to, an HTTP or HTTPS request, e.g., a printer or a hypertext markup language (HTML) document. HTTP or HTTPS requests are usually generated using a web browser.

Secure web exporting as achieved by the use of capability-enabled uniform resource locators (URLs) does not require authentication of the user, or the location of the client, but may complement user or client location authentication. Capabilities are used to represent URLs of resources within the domain 200. In order to use a capability, a client 203 must present the capability to a reverse proxy server 201 running on the firewall of the domain 200.

The reverse proxy server 201 is distinguished from a conventional proxy server in that it handles request directed into the network with which it is associated rather than handling requested directed out of the network. A reverse proxy server may be capable of performing the conventional functions of caching and filtering requests, but its principal function is to process the URLs of incoming requests to determine whether access to a network resource should be granted and on what conditions.

Upon receiving a capability-enabled URL, the reverse proxy server verifies its authenticity and then issues a request to the intranet web server 202 which manages the resource. The intranet web server 202 services the request and returns any result to the user. Successful accesses may be logged by either the reverse proxy server or the intranet web server.

A capability takes the form of a URL, comprising the text address of a reverse proxy server for the domain, plus a string encoding an identifier for the resource within the domain 200. As such, the capability is transparent to protocols such as HTTPS or HTTP.

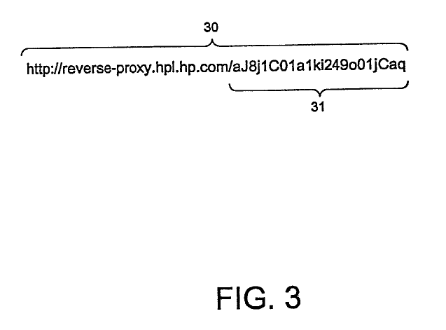

FIG. 3 shows a capability-enabled URL 30 having a capability character string 31. In this particular instance, the capability character string 31 is a string of 22 ASCII characters that is the result of encoding a 64-bit identifier and a 64 bit random number using an encoding method similar to base 64 encoding, in which each character nominally represents six bits. The use of an encoding process is desirable since the entire ASCII character set is not available for use in a URL due to the designation of reserved characters in URLs, particularly in the path or query segments. Gateways and other transport agents may further restrict the usable character set. Also it is more convenient to use a character set that can be found on typical keyboards. For example, replacing the “+”, “/”, and “=”of the conventional 65 character Base 64 alphabet with “_” “(” and “)” would provide a modified Base 64 alphabet suitable for encoding a capability for use in a URL that is accessible from standard keyboards. The smaller character sets result in less compact character strings, but may be more convenient for keyboards or keypads with limited characters. An alternative to avoiding the use of reserved characters for encoding is to use the ”%” escape sequence in conjunction with the reserved character in the capability.

The URL shown in FIG. 3 belongs to a subset of the more general Uniform Resource Identifier (URI) to which the present invention is applicable. The generic syntax of a URI can be separated into a scheme and a scheme-dependent part. The capability character string of the present invention is inserted in the scheme dependent part of the URI, e.g., a path or query segment.

The identification number portion of the capability corresponds to a database record in which the characteristics of the capability are stored. The random number portion of the capability is used to thwart an attempt to gain access by a “trial and error” process of manufacturing capabilities. At the time of invocation, both the identification number and the random number must correspond to a single record in the database.

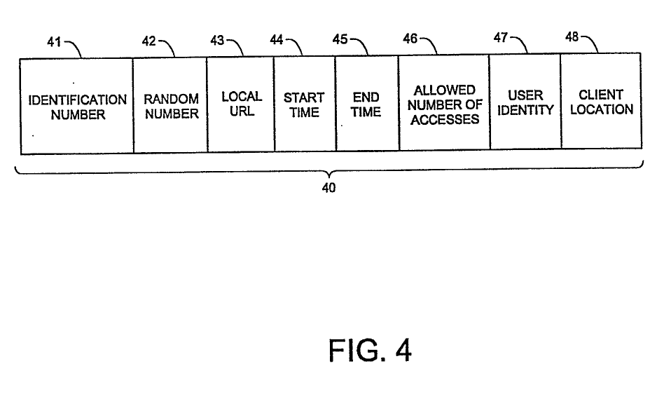

FIG. 4 shows an example of a capability database record 40 maintained for a capability. Which includes an identification number 41 and a random number 42. In the example described above, these are both 64-bit quantities; however, other bit lengths may be used depending upon how many outstanding capabilities are anticipated and the degree of resistance to guessing attacks that is desired. The local URL string field 43 is used to store the local URL for the resource associated with the capability. The start time field 44 allows the issuer of the capability to set the time at which the capability becomes active, and the end time field 45 allows the issuer of the capability to set the time at which the capability is disabled. The allowed number of accesses field 46 is used to limit the number of times that the resource associated with the record is accessed. The user identity field 47 is used to associate the capability with a specific user or group of users. The client location field 48 is used to associate the capability with a particular client location. Each resource available on a network has a list of records for the capabilities that have been issued for that resource.

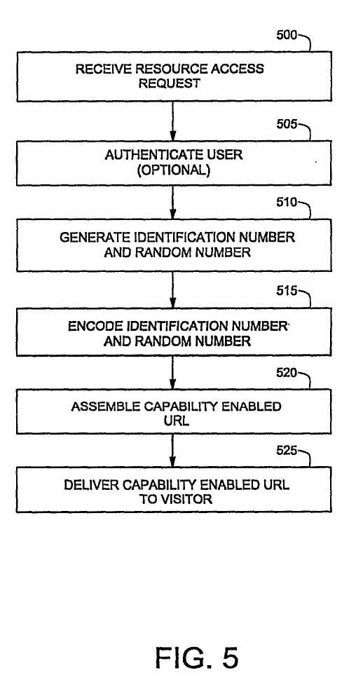

FIG. 5 shows a flow chart for the process of providing a capability-enabled URL in accordance with an embodiment of the present claimed invention. The steps of the process flow chart of FIG. 5 will be referenced to the network shown in FIG. 2.

In step 500 of FIG. 5, The reverse proxy server 201 of receives a resource request from a client 203. The request is typically transmitted using a web browser and Hypertext Transport Protocol (HTTP) or HTTP using a Secure Sockets Layer (HTTPS); however, the request could also be written (e.g., an email or facsimile) or verbal (e.g. a phone conversation). The resource may be an Hypertext Markup Language (HTML) document on the intranet web server 202.

In step 505, the identity of the requester is authenticated. This step is optional. Authentication may be done using passwords, keys and the like, or may be as simple as recognizing an individual making a verbal request face-to-face. Authentication may also be implicit. An example of implicit authentication would be a request made by a person from a location that has restricted access. In this case access to the restricted location implies access to the requested resource.

In step 510, the reverse proxy server 201 generates an identification number and a random number, and creates a database record for the capability. The identification number is a unique number used to track the capability that is being created. The identification number imparts its uniqueness to the subsequent capability character string. As shown by the example in FIG. 4, the database record may also contain other parameters that will affect the exercise of the capability, such as the path for the resource and restrictions on use.

In step 515, the identification number and random number are encoded into a character string using an ASCII character subset that is compatible with the syntax of a URL. It is also preferable that the character string be compatible with gateways and other transfer agents that may be employed on the network. It is also preferable that the ASCII character subset be a subset of characters found on typical keyboards and keypads.

In step 520 the capability enable URL is assembled. The capability character string is combined with the path of a reverse proxy server that is able to access the database record and process the capability, and other elements required to produce a complete URL. It should be noted that the example presented herein refers to a URL; however, the present invention may be used with the more general Uniform resource Identifier (URI).

The capability generation process of the reverse proxy server is coordinated with the server responsible for local administration in order to avoid ambiguous URLs. Due to the random nature of capability character string generation, there is a possibility that the complete URL produced in response to a request may be identical to an existing URL, or that a URL created for a new resource might be identical to an existing capability-enabled URL.

In step 525, the capability-enabled URL is delivered to the user, such as client 203. As in the initial receipt of the request for access, the capability-enabled URL may be delivered in several different ways.

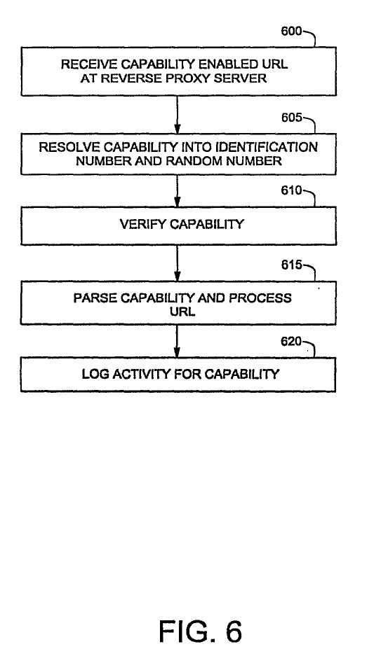

FIG. 6 shows a flow chart for the process of using a capability-enabled URL in accordance with an embodiment of the present claimed invention. The steps of the process flow chart of FIG. 6 will be referenced to the network shown in FIG. 2.

In step 600, the reverse proxy server 201 receives a capability-enabled URL. The capability character string may be recognized as such by referring to the table used to track issued capabilities and avoid capability/URL ambiguity.. Alternatively, all URLs having a character string conforming to the length and composition conforming to the established capability format (allowing for escape sequences if present) may be passed to step 605.

In step 605, the character string is resolved into an identification number and a random number by reversing the encoding process used to encode the character string.

In step 610, the capability is verified by first determining whether the resolved identification number corresponds to a database record. If a database record exists for the identification number, the decoded expected random number is checked for a match with the random number in the identified database record. If a record exists for the decoded identification number and the random number in the record matches the expected random number, then the capability is accepted as genuine. If either the identification number or random number does not match, the request is rejected and can either be ignored or responded to with an error message.

In step 615 the capability is parsed and the URL for the resource is processed. The database record is examined for any restrictions and requirements that may be associated with the capability such as a start time, and end time and the number of allowable accesses. Each requirement or restriction is checked to determine the validity of the capability. The URL that contains the capability character string may also have a query and arguments or other elements that may be passed on or modified. Once all of the elements of the capability have been reconciled, a URL is generated for the requested resource. This URL may be serviced by the reverse proxy server 201, but is typically serviced by a server inside the firewall 200 such as the Intranet Web Server 202.

In step 620, the activity for the capability is logged. Such logging may include recording the number of accesses, recording the number of attempted accesses associated with a given identification number, user identity, client location, etc.

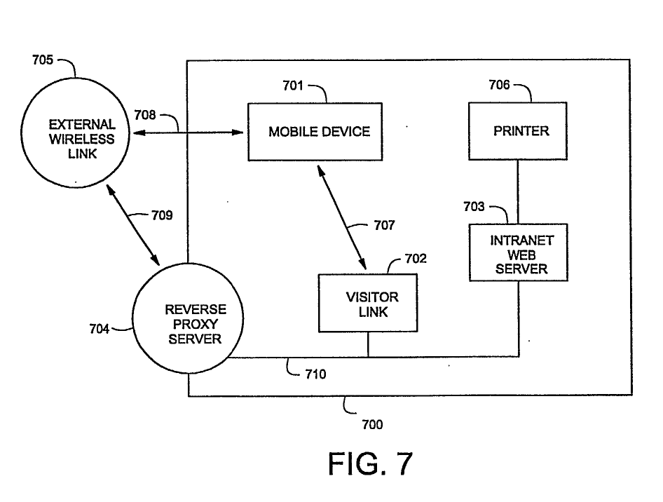

FIG. 7 shows a network scenario in which capabilities may be used to provide resources to a mobile device. For example, a visitor to a laboratory that is served by a firewall protected domain 700 wishes to make use of a public printer to get a hard copy of a document stored on his or her mobile device. Since the presence of a visitor in a laboratory implies a degree of trust, the visitor may use the mobile device (e.g. a handheld wireless device) to request a capability for printing on a local printer 706 by accessing a visitor link 702 across a local channel 707. The visitor link may be an Infrared port, Universal Serial Bus (USB) port or other suitable port. The local channel 707 may be a signal conducted on a cable or transmitted/received through space by electromagnetic radiation. Security requirements will influence the method used for transmitting a capability-enabled URL to a visitor. The visitor link 702 is coupled to a local network 710 that includes an intranet web server 703, a printer 706 and a reverse proxy server 704. A capability-enabled URL is provided to the mobile device 701 over the local channel 707 and visitor link 702. The mobile device then transmits an HTTP request including the capability to the external wireless link 705 over a wireless channel 708. The wireless channel 708 is a signal transmitted/received by electromagnetic radiation. The external wireless link 705 is coupled to the reverse proxy server 704 by a client channel 709. The client channel 709 may be wired or wireless. The wireless link 705 then forwards the HTTP request including the capability-enabled URL to the reverse proxy server. The reverse proxy server then verifies and processes the capability-enabled URL and forwards the request to the printer 706.

As previously described, capabilities for web pages can have their of use restricted by the reverse proxy server. It is common for web servers to generate content dynamically by executing a script in response to a web request, by employing the Common Gateway Interface (CGI) format. A web request to a CGI script can be accompanied by a list of argument-value pairs to control the script's behavior. There is a well-known problem with bogus arguments to CGI scripts subverting the behavior of the script in ways the script writer did not intend, which is potentially even worse if scripts designed to run in the protected environment inside a firewall are allowed to be invoked from the outside.

Secure web exporting allows the specification of rules regarding the type and content of arguments for a CGI script invoked through a capability. It is possible to list the acceptable arguments, or explicitly exclude certain arguments, and add to or replace values for arguments which the user has specified in the request.

Finally, we point out that since a capability is opaque, we can specify arguments to the CGI script it refers to without the user of the capability being able to change them. For instance, the capability with identifier string “aJ8jlC01alki249o01jCaq” might refer to a CGI script with the URL ”http://internal.hpl.hp.com/cgi-bin/script?colour=red” and an invocation of the script through the capability would automatically contain the colour=red argument. By a sensible scheme, the arguments provided by the user could be combined with these “automatic” arguments, either simply by appending, or overriding the user's arguments if there is a conflict, so that the colour=red argument could not be altered.

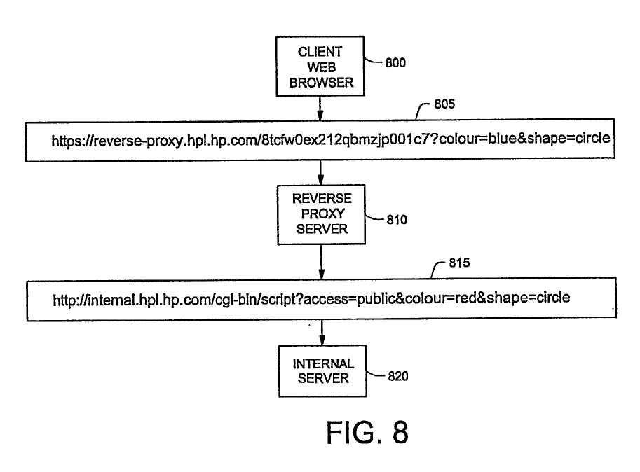

FIG. 8 shows a flow chart for the resolution of a common gateway interface (CGI) script in accordance with an embodiment of the present claimed invention. A client web browser 800 submits a capability-enabled URL 805 to the reverse proxy server 810 along with the arguments “colour=blue” and “shape=circle” . The Reverse proxy server 910 then resolves the capability to a URL for a CGI script that has the additional arguments “access=public”. “colour=red” and “shape=circle”. The arguments of the capability and those provided by the browser are merged to produce the URL 815. In this example, the CGI script argument “colour=red” overrides the argument “colour=blue” provided by the browser, and the “shape=circle” argument is passed through to the CGI script unchanged.

Managing access control with capabilities for URLs is difficult to administer once a user has access to more than a few resources. In practice, access is granted to a set of resources at a time (for instance, a subset of the URLs stored on a web server), which introduces complexity and administration problems.

These problems are solved with the secure containers mechanism. A secure container is a logical entity which groups a set of web pages (or other web resources) into a single logical unit. It corresponds to a subset of the web resources within a firewall which a particular class of external users can have access to. Access is granted to the entire contents of a container together: for instance, a container might contain all the resources which a visitor to a research lab is allowed to access. Granting a user access to the container corresponds to generating capabilities for all the URLs in the container. An administrator only has to add URLs to the container once, and then a set of capabilities can be generated for a new user at the touch of a button.

In practice, adding documents to a secure container is a recursive process, since most HTML documents contain links to other documents. The creator or maintainer of the container adds a web page to the container and specifies the characteristics of the corresponding capability (limited use, time limit, and so on). The container then parses the HTML and extracts the links for all the “follow-on” documents. The links are annotated according to whether they point to web pages inside or outside the firewall. Pages outside do not need capabilities, but pages inside require a decision by the container maintainer: either a page is added to the container, or the link to it is nullified (for instance, it may be replaced by a link to an “access disallowed by security policy” link). The process is repeated recursively for each newly-added page.

A secure container is an active entity: when a page is requested by an external user who presents a capability for the page, the reverse proxy cannot simply return the page unmodified. The page may contain links to other pages within the firewall, in which case the container must be consulted to determine how they must be modified. Links to pages within the container are replaced by capabilities appropriate for the user, and links to pages within the firewall, but outside the container, must be nullified as explained in the preceding paragraph. This procedure is referred to as “URL rewriting”.

CGI scripts represent another potentially difficult case, since it may be impractical to predict what links the pages they return can contain, and therefore capabilities for the appropriate pages cannot be generated ahead of time. Secure containers can be used to manage access involving CGI scripts.

The maintainer of the container makes an assessment of the links that the generated page will contain, and the resources associated with the anticipated links may be placed in the secure container ahead of time. The reverse proxy server parses the CGI script's HTML output searching for all links. The reverse proxy server processes them as though that page has just been added to the secure container before passing the transformed HTML back to the client.

There are three possible cased to be considered for the links generated by the CGI script. First, the link may point to a resource that is external to the firewall, in which case it may be passed to the client as is. In the second case, a link may point to a resource inside the firewall, but outside of the secure container, in which case the link is nullified. In the third case the link points to a resource inside the firewall and inside the secure container, and the link is enabled for the client.

Finally, the possibility that documents, and the links they contain, may change cannot be ignored. In a large company, these changes may occur without the knowledge of the container maintainer. Our scheme provides a choice to the maintainer: a physical copy can be made of a document when it is added, and that is the version returned to the user; or alternatively, the document is retrieved on every reference to get the freshest version. If a new version contains new links to resources outside the container, these are nullified, and the maintainer is notified that the container is stale. the maintainer should then decide whether to admit the new documents to the container or permanently nullify them.

A secure container is a virtual container that contains a set of resources which a user can have access to. It should be noted that a secure container is a logical construct that is transparent to normal users of the network. The construction of a secure container may reside in a database record associated with the capability that grants access to the secure container.

A secure container can also be correlated with a user interface. Since secure web exporting protects resources such as web pages, a resource may refer to further resources by links on its web page. Which of these resources can also be accessed is a policy decision, to be made by the person who permits access to the resource. Granting external access to a page through a capability-enabled URL may be viewed as placing it in a secure container. Performing this operation also implies specifying the constraints on the capability for the page, such as lifetime and number of uses.

An external user can access a page within a container, but can only follow links from that page in so far as they refer to further pages inside the container, or point outside the domain entirely. When a page is placed inside the container, the person who performs the operation is alerted if any links point to resources inside the domain, but outside the container, so that the inconsistency can be rectified. An analogous procedure is performed when directories or trees of pages are added to the container.

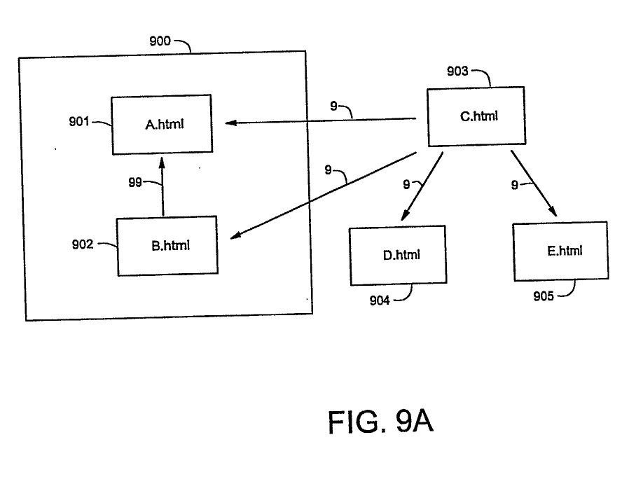

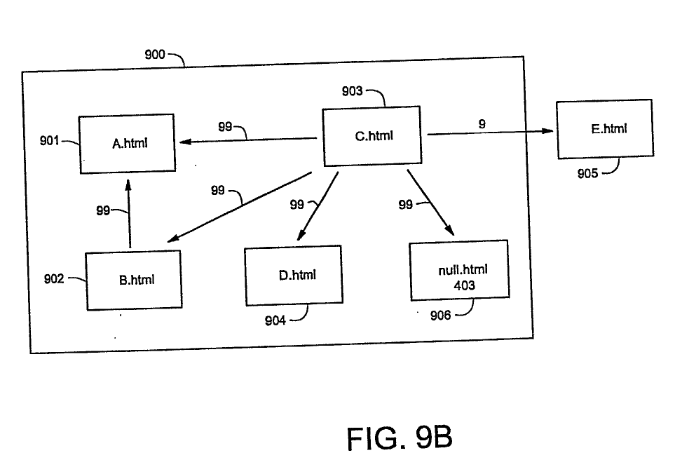

FIG. 9A shows a secure container 900 having documents 901 and 902, and documents 903, 904 and 905 outside the secure container 900 to be added to the secure container in accordance with an embodiment of the present claimed invention. A series of links 8 shown as arrows connect documents 901, 902, 904, and 905 to document 903, and a capability link 99 shown by an arrow links document 902 to document 901. The arrow pointing from the document having the link document to the document referenced by the link. The link 9 is a conventional hypertext link, and its function is not affected by the presence of a secure container 900 or capability links 99. The capability link 99 is a hypertext link that has its functionality conditioned on a capability.

When an external user retrieves a page using a capability, the links 9 to pages within the same container are replaced by capability links 99, links to resources outside the container are nullified, and links to pages in the general Internet are left untouched. A nullified link may point to a publicly-readable “resource-not-accessible” page.

A container can either be restricted to a single class of principal, for instance, unprivileged visitors, and give access to all the documents inside it; or it can be a procedure taking an argument specifying the class of the principal to be given access, and returning only a subset of the capabilities for its resources. In this case, placing a resource in the container would require an annotation specifying the principals who can access it. The former option has the advantage of a simpler implementation, while the latter simplifies management, since it is easy to see who can access a particular resource from outside the domain. A related issue concerns the persistence of containers: the container-as-procedure view naturally implies that containers are long-lived objects, while the unparameterized container could be generated on-the-fly to give temporary access, as for instance in the remote printing scenario outlined earlier.

Implementing secure containers also requires some choices. Placing a page in a container results in extraction of the links it contains. This information is used to decide if additional pages need to be added. Adding pages therefore results in metadata about the pages and links between them being added to the container. Since this information embodies policy decisions made by the person who added the documents to the container, it is not automatically generated, and so a method for maintaining consistency between the document metadata and the documents themselves is needed.

A document can be added to a secure container in two ways: first, adding the document “freezes” it, meaning that all capability-enabled URLs will access that version; or second, the user performing an access sees the most recent version. These variants are called copy-on-add and latest-version.

Using copy-on-add, the contents of the document are fixed as being those which were present at the time of adding, so that subsequent additions or deletions will not be visible to the user. This is implemented by making a physical copy of the document and storing it with the container, or storing a timestamp when the document is added, and disallowing access if the last modification time of the document is ever greater than this timestamp.

The copy-on-add scheme may be unsuitable for dynamically-changing content which is intended to be externally viewable, but it provides protection against the risk of information “leaking” outside the protected domain unintentionally.

The latest-version scheme always displays the newest copy of the document when a user invokes a capability for it, complete with changes made since the document was added to the container. This allows the user to see updates, but admits the possibility of information leakage, or new links being added, which have not been added or disallowed from the container. However, it does permit the reverse proxy to notify the maintainer of the container (for instance, by e-mail) if a link is added to the page without updating the container metadata. The choice of which scheme to use depends on the requirements of the container and the individual web page.

FIG. 9B shows a reconfiguration of the secure container 900 of FIG. 9A by the addition of document 903 to the secure container 900. In FIG. 9B, document 903 has been added to the secure container 900 along with the linked document 904. However, linked document 905 of FIG. 9A has not been placed in the secure container 900. Document 905 has been replaced by a null document 906 that presents an error message or otherwise indicates that document 905 is inaccessible from within the secure container 900. As shown by the link 9 between document 903 and document 905, the existing link visible to regular users of the network is still intact.

The preferred embodiment of the present invention, a capability-enabled URL, is thus described. While the present invention has been described in particular embodiments, it should be appreciated that the present invention should not be construed as limited by such embodiments, but rather construed according to the below claims.

1. A communications network with controlled access to web resources comprising:
an intranet having a firewall and a web enabled resource;
a reverse proxy server for controlling access to said intranet coupled to said intranet and coupled to said web browser enabled client, said reverse proxy server having a database with a record associated with said web enabled resource, said record containing a unique identification number and a random number;
wherein access to said web enabled resource is granted to a web browser enabled client in response to submission of a uniform resource identifier (URI) containing a character string produced by an encoding of said identification number and said random number to said reverse proxy server.

2. The communications network of claim 1, wherein said web enabled resource comprises a printer.

3. The communications network of claim 1, wherein said web enabled resource comprises a hypertext markup language (HTML) document.

4. The communications network of claim 1, wherein said web browser enabled client is coupled to said reverse proxy server by a wireless communications link.

5. The communications network of claim 4, wherein said web browser enabled client is also coupled to said intranet by a wireless communications link.

6. The communications network of claim 1, wherein said URI is submitted using hypertext transfer protocol (HTTP).

7. The communications network of claim 1, wherein said URI is submitted using hypertext transfer protocol with secure socket layer (HTTPS).

8. The communications network of claim 1, wherein said character string is encoded using six bits or less per character.

9. The communications network of claim 8 wherein said character string is encoded using base 64 encoding.

10. The communications network of claim 1, wherein said record further includes a start time designating the time at which access is enabled.

11. The communications network of claim 1, wherein said record further includes an end time designating the time at which access is disabled.

12. The communications network of claim 1, wherein said web enabled resource is a CGI script.

13. The communications network of claim 1, wherein said web enabled resource is contained in a secure container.

14. A method for providing access to a resource on a communications network comprising:
associating an identification number and a random number with said resource;
encoding said identification number and said random number into a first character string using a coding method;
receiving a request for access to said resource, said request including a uniform resource identifier (URI) having a scheme dependent part , said scheme dependent part further including a second character string with a length identical to the length of said first character string;
decoding said second character string into a first number and a second number using said coding method;
comparing said first number to said identification number;
comparing said second number to said random number; and,
granting access to said resource if said first number matches said identification number and said second number matches said random number.

15. The method of claim 14, wherein said URI further includes a query.

16. The method of claim 14, wherein said URI is received using hypertext transfer protocol (HTTP).

17. The method of claim 14, wherein said URI is received using hypertext transfer protocol with secure socket layer (HTTPS).

18. The method of claim 14, wherein said record further includes a start time indicating the time at which said access is enabled.

19. The method of claim 14, wherein said record further includes an end time indicating the time at which said access is disabled.

20. The method of claim 14, wherein said record further includes a log for counting the number of accesses granted.

21. The method of claim 20, wherein said record further includes a limit on the number of accesses.

22. A reverse proxy server for controlling access to a web enabled resource on a communications network comprising:
a database record associating an identification number, a random number and a first character string with said resource, wherein said character string is the product of encoding said identification number and said random number;
a means for receiving a request for access to said resource, wherein said request includes a uniform resource identifier (URI) having a scheme dependent part, said scheme dependent part further including a second character string with a length identical to the length of said first character string;
a processor means for decoding said identification number and said random number into a first character string
a processor means for comparing said first number to said identification number; and
a processor means for comparing said second number to said random number.

23. The reverse proxy server of claim 22, wherein said URI further includes a query.

24. The reverse proxy server of claim 22, wherein said means for receiving a request uses hypertext transfer protocol.

25. The reverse proxy server of claim 22, wherein said means for receiving a request uses hypertext transfer protocol with secure socket layer (HTTPS).

26. The reverse proxy server of claim 22, wherein said record further includes a start time indicating the time at which said access is enabled.

27. The reverse proxy server of claim 22, wherein said record further includes an end time indicating the time at which said access is disabled.

28. The reverse proxy server of claim 22, wherein said record further includes a log for counting the number of accesses granted.

29. The reverse proxy server of claim 28, wherein said record further includes a limit on the number of accesses.

30. The reverse proxy server of claim 22, wherein said web enabled resource is a CGI script.

31. The reverse proxy server of claim 22, wherein said web enabled resource is contained in a secure container.
